(19) United States
(12) Patent Application Publication
(10) Pub. No.: US 2006/0261817 A1
(43) Pub. Date: Nov. 23, 2006

(54) System and method for testing a photovoltaic module

(76) Inventor: James J. Poddany, Northwood, OH (US)

Correspondence Address: STEPTOE & JOHNSON LLP, 1330 CONNECTICUT AVENUE, N.W., WASHINGTON, DC, 20036, US

(21) Appl. No.: 11/411,878

(22) Filed: Apr. 27, 2006

Related U.S. Application Data
(60) Provisional application No. 60/676,293, filed on May 2, 2005.

(51) Int. Cl. G01N 25/00

(52) U.S. Cl. 324/451

(57) ABSTRACT

A method and apparatus for testing a photovoltaic module includes loading a photovoltaic module onto a connector and connecting the module to the connector. The connector rotates on an axis through various test stations. Each test station is associated with a test apparatus for testing a specific electrical characteristic of the photovoltaic module. As the connector rotates the connected photovoltaic module to a test station, a connection is formed between the photovoltaic module and the test apparatus associated with the test station.

### CLAIM OF PRIORITY

This application claims priority to U.S. provisional patent application No. 60/676,293, filed May 2, 2005, which is incorporated by reference in its entirety.

### TECHNICAL FIELD

The present invention relates to photovoltaic module production.

### BACKGROUND

In the manufacture of a photovoltaic module, various electrical characteristics of the module are tested. This may be accomplished by connecting the module to test equipment located at various test stations. After the module is connected to the test equipment at a test station, the module is tested for a specific characteristic. The module may then be positioned at another test station, where the module is connected to a second test equipment and tested for a second characteristic. The fitness of the module's tested characteristics is determined by the comparing test data resulting from the tests to control data. If the test data for a particular photovoltaic module are not sufficiently in line with the control data, the photovoltaic module is held back from further processing and is either destroyed or repaired.

### SUMMARY

In general, a system and method for testing a photovoltaic module includes introducing a photovoltaic module to a position on a rotatable connector. The photovoltaic module is electrically connected to the connector. The connector rotates from a load station to various test stations at which the photovoltaic module is tested with respect to various electrical characteristics. As the connector rotates through the test stations, the photovoltaic module can remain connected to the connector, and a connection between a particular test station is accomplished by completing an electrical connection between the test apparatus corresponding to each test station and the photovoltaic module. Test data from the tests may be saved and compared with control data to determine the quality of the tested photovoltaic module. After the connector and the photovoltaic module rotates through the test stations, the photovoltaic module may be disconnected and unloaded from the connector at an unloading station. If the test data for each test are within acceptable tolerances compared to the control data, the tested photovoltaic module can be further processed.

In one aspect, a system for testing a photovoltaic module includes a rotatable connector configured to be electrically connected to a photovoltaic module and to test apparatus. The system includes a loading station where a photovoltaic module to be tested is positioned on the connector. After the photovoltaic module is positioned, it can be electrically connected to the connector by one or more wire leads from the photovoltaic module. The system includes a plurality of test stations at which the photovoltaic module is tested. When the connector rotates to a test station, an electrical connection exists between a test apparatus and the connector. This connection is extended from the connector to the photovoltaic module, creating an electrical connection between the photovoltaic module and the test apparatus corresponding to the test station where the photovoltaic module is positioned. After a connection is established between the photovoltaic module and the test apparatus, the photovoltaic module is tested using the test apparatus. The connector can include subsequent test stations having test equipment for testing various other electrical characteristics of the photovoltaic module. As the connector rotates to subsequent test stations, a connection is formed between corresponding test apparatus and the connector, which remains electrically connected to the photovoltaic module. This enables connections to be made between the photovoltaic module and various test equipment via the connector as the connector is positioned according to a specific test apparatus. The system includes an unload station at which the tested photovoltaic module is disconnected and unloaded from the connector.

In another aspect, a method for testing a photovoltaic module includes loading a photovoltaic module to be tested onto a connector and forming an electrical connection between the photovoltaic module and the connector. The electrical connection can be made with wire leads from the photovoltaic module. The connector is rotated to a test station associated with a test apparatus for testing a specific electrical characteristic of the photovoltaic module. When the connector rotates the photovoltaic module to the test station, an electrical connection between the connector and the test apparatus and the photovoltaic module is made through the connector. After an electrical connection is established between the photovoltaic module and the test apparatus, the photovoltaic module is tested. Test data corresponding to the photovoltaic module can be generated, saved and compared to control data in order to assess the quality of the photovoltaic module with respect to the tested electrical characteristic. After the photovoltaic module is tested at the test station, the connector may rotate to a second test station associated with a test apparatus for testing an additional electrical characteristic, which can electrically disconnect the photovoltaic module from the first test apparatus. As with the first test station, when the connector rotates the photovoltaic module to the second test station, an electrical connection between the photovoltaic module and the second test apparatus is made through the connector. The photovoltaic module is then tested and evaluated with respect to a second electrical characteristic. After the photovoltaic module is tested at the second test station, it can rotate to a subsequent test station or to an unload station, which can in either case electrically disconnect the photovoltaic module from the second test apparatus. If the photovoltaic module is rotated to an unload station, it is electrically disconnected from the connector and removed from the connector for further processing. The photovoltaic module can be moved to and from the connector by any suitable means, including suction cups used to lift the photovoltaic module between conveyors and the connector.

The system and method described here have various advantages over known systems and methods of testing a photovoltaic module. For example, known systems and methods require multiple connections for multiple tests, and exhibit wear and tear to test wires. The described system and method reduces wear and tear to test wires, which in turn decreases the likelihood of their having to be replaced or repaired as a result of the testing. This is advantageous in that it reduces time delays caused by wire repair and replacement and also increases the reliability of test results which may otherwise be compromised by broken or worn wires.

The system and method described here are also advantageous over known systems in that it does not require a photovoltaic module being tested to be stopped, disconnected, lifted by suction cups, positioned, and reconnected between each test. The described system and method integrates with an inline conveyor system, reducing the time required for testing each photovoltaic module. This results in higher efficiency in the production of photovoltaic modules than is provided with known methods and systems.

The details of one or more embodiments are set forth in the accompanying drawings and the description below. Other features, objects, and advantages will be apparent from the description and drawings, and from the claims.

### DESCRIPTION OF DRAWINGS

FIG. 1 is a drawing depicting a system at a stage of testing a photovoltaic module.

FIG. 2 is a drawing depicting a system at a stage of testing a photovoltaic module subsequent to the stage of testing depicted in FIG. 1.

FIG. 3 is a drawing depicting a system at a stage of testing a photovoltaic module subsequent to the stage of testing depicted in FIG. 2.

FIG. 4 is a drawing depicting a system at a stage of testing a photovoltaic module subsequent to the stage of testing depicted in FIG. 3.

### DETAILED DESCRIPTION

A photovoltaic module to be tested is introduced into a testing system by removing it from an inline conveyor to a rotatable connector which establishes connections between the photovoltaic module and various test equipment. Each test apparatus is located at a test station at a point peripheral to the connector. An electrical connection between the photovoltaic module and a test apparatus is established when the photovoltaic module is rotated into a test station corresponding to the particular test apparatus. After the photovoltaic module is tested, it is disconnected and removed from the connector for further processing based on the results of the tests.

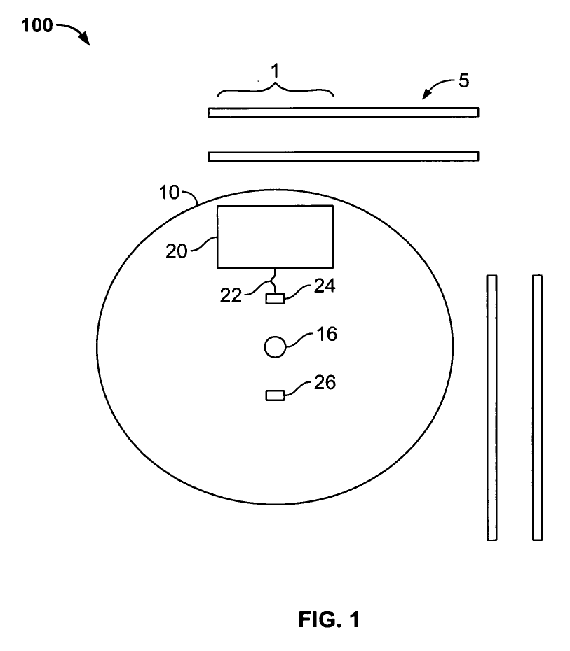

With reference to FIG. 1 of the drawings, a testing system 100 includes a photovoltaic input bank 5 which transports a photovoltaic module 20 into load station 1. Input bank 5 may include a conveyor apparatus suitable for transporting photovoltaic module 20. After photovoltaic module 20 is transported to load station 1, it is moved from input bank 5 to connector 10, which may be a dial rotatable around axis 16. Photovoltaic module 20 can be moved from input bank 5 to connector 10 by lifting and positioning photovoltaic module 20 with suction cups or another suitable lifting or positioning apparatus.

Photovoltaic module 20 includes wire lead 22 connected to a circuitry of photovoltaic module 20 to be tested. Wire lead 22 is electrically connected to connector 10 at a suitable location on connector 10, such as first connection block 24. This connects the circuitry of photovoltaic module 20 to circuitry of connector 10. Multiple locations for connecting multiple photovoltaic modules may be included in connector 10. For example, a second connection block 26 may be provided for connection of a second photovoltaic module. This allows multiple photovoltaic modules to be connected to connector 10 simultaneously. As a result, multiple photovoltaic modules may be tested simultaneously with connector 10.

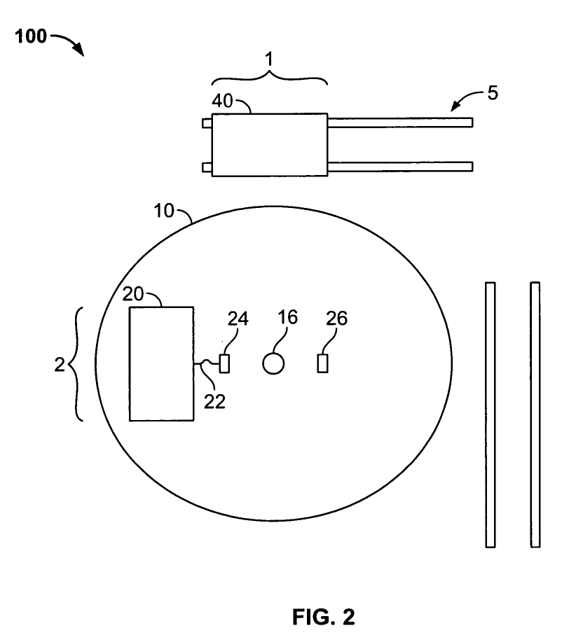

Referring to FIG. 2, connector 10 of testing system 100 is rotated on axis 16 such that photovoltaic module 20 is moved from load station 1 to a first test station 2. Moving connector 10 such that photovoltaic module 20 is positioned in first test station 2 causes an electrical connection to be formed between photovoltaic module 20 and a first test apparatus associated with first test station 2. For example, as connector 10 rotates photovoltaic module 20 into first test station 2, a conductive path from the first test apparatus associated with first test station 2 to first connection block 24 can be formed, completing an electrical connection between the first test apparatus and photovoltaic module 20. In this manner, the first test apparatus is electrically connected through first connection block 24 and wire lead 22 to circuitry of photovoltaic module 20.

After the electrical connection between the first test apparatus and photovoltaic module 20 is completed at first test station 2, the test performed by the first test apparatus can commence. The first test apparatus can test electrical characteristics of photovoltaic module 20. For example, the first test apparatus can be a current-voltage (“I-V”) tester for testing current and voltage characteristics of circuitry of photovoltaic module 20. Alternatively, the first test apparatus can be a high potential (“HiPot”) tester, which applies a high voltage to circuitry of photovoltaic module 20 to test the ability of the photovoltaic dielectric to withstand a high voltage. It should be apparent that a first test apparatus can be selected to test any known electrical characteristics of the circuitry of photovoltaic module 20.

Testing circuitry of photovoltaic module 20 with the first test apparatus can generate test data, which can be saved in an electronic storage medium and compared to control data to determine the quality and fitness of the tested circuitry of photovoltaic module 20 with respect to the test performed by the first test apparatus.

With continuing reference to FIG. 2, the rotation of connector 10 such that photovoltaic module 20 into first test station 2 also rotates second connection block 26 toward load station 1. As depicted in FIG. 2, as photovoltaic module 20 is positioned in first test station 1, a second photovoltaic module 40 can be transported by input bank 5 into load station 1. As described above, second connection block 26 provides a location for connecting a second photovoltaic module 40 to connector 10, which enables multiple photovoltaic modules to be positioned on connector 10 simultaneously.

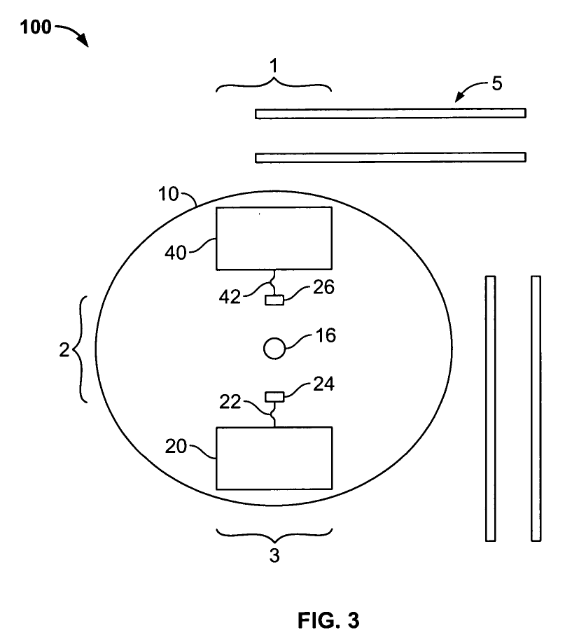

Referring now to FIG. 3, connector 10 of test system 100 is rotated on axis 16 such that photovoltaic module 20 is rotated from first test station 2 to second test station 3. As described above with reference to photovoltaic module 20, second photovoltaic module 40 can be removed from input bank 5 and loaded and connected to connector 10 at load station 1. This connection can be made at a suitable location provided in connector 10, such as second connection block 26. The connection can be made with wire lead 42 from second photovoltaic module 40, which can connected circuitry of second photovoltaic module 40 to circuitry of connector 10.

Moving connector 10 such that photovoltaic module 20 is positioned in second test station 3 causes an electrical connection to be formed between photovoltaic module 20 and a second test apparatus associated with second test station 3. For example, as connector 10 rotates photovoltaic module 20 into second test station 3, a conductive path from the second test apparatus associated with second test station 3 to first connection block 24 can be formed, completing an electrical connection between the second test apparatus and photovoltaic module 20. In this manner, the second test apparatus is electrically connected through first connection block 24 and wire lead 22 to circuitry of photovoltaic module 20.

After the electrical connection between the second test apparatus and photovoltaic module 20 is completed at second test station 3, the test performed by the second test apparatus can commence. As described above with reference to the first test apparatus, the second test apparatus can test electrical characteristics of photovoltaic module 20. For example, the second test apparatus can be a I-V tester for testing current and voltage characteristics of circuitry of photovoltaic module 20. Alternatively, the second test apparatus can be a HiPot tester, which applies a high voltage to circuitry of photovoltaic module 20 to test the ability of the photovoltaic dielectric to withstand a high voltage. It should be apparent that a second test apparatus can be selected to test any known electrical characteristics of the circuitry of photovoltaic module 20.

As with the first test apparatus, testing circuitry of photovoltaic module 20 with the second test apparatus can generate test data, which can be saved in an electronic storage medium and compared to control data to determine the quality and fitness of the tested circuitry of photovoltaic module 20 with respect to the test performed by the second test apparatus.

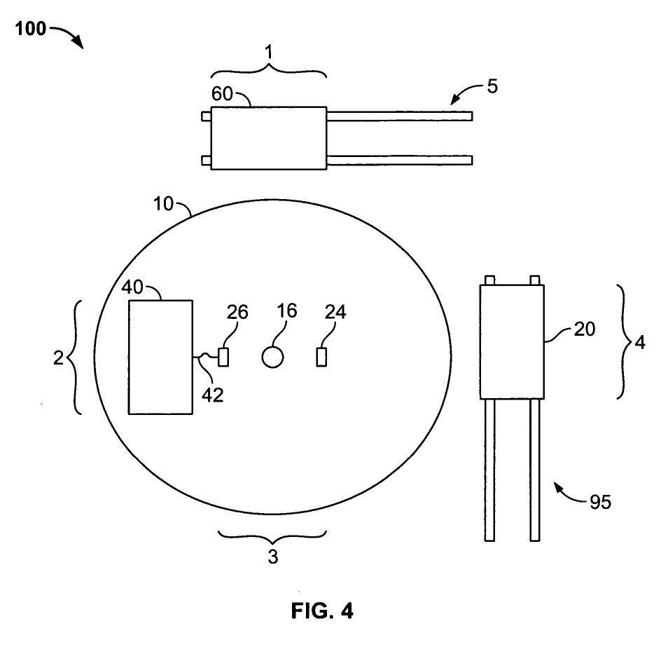

Referring now to FIG. 4, connector 10 of testing system 100 is rotated on axis 16 such that photovoltaic module 20 is rotated from second test station 3 to unload station 4. Photovoltaic module 10 disconnected from connector 10 by disconnecting the wire lead from first connection block 24. Photovoltaic module 20 is then removed from connector 10 an positioned on output bank 95, which may be any conveyor suitable for removing photovoltaic module 20 from unload station 4. Typically, if photovoltaic module 20 is deemed to have met the requirements of the tests performed while connected to connector 10, photovoltaic module 20 can be transported on output bank 95 to subsequent processing steps on the photovoltaic module production line. As with load station 1, photovoltaic module 20 may be moved from connector 10 to output bank 95 with suction cups or any other suitable lifting or positioning apparatus.

As shown in FIG. 4, when photovoltaic module 20 is located in unload station 4, second photovoltaic module 40 can be positioned in first test station 2. As noted above with reference to photovoltaic module 20, moving connector 10 such that second photovoltaic module 40 is positioned in first test station 2 causes an electrical connection to be formed between second photovoltaic module 40 and a first test apparatus associated with first test station 2. For example, as connector 10 rotates second photovoltaic module 40 into first test station 2, a conductive path from the first test apparatus associated with first test station 2 to second connection block 26 can be formed, completing an electrical connection between the first test apparatus and second photovoltaic module 40. In this manner, the first test apparatus is electrically connected through second connection block 26 and wire lead 42 to circuitry of second photovoltaic module 40.

After the electrical connection between the first test apparatus and second photovoltaic module 40 is completed at first test station 2, the test performed by the first test apparatus can commence. As described above, the first test apparatus can test electrical characteristics of second photovoltaic module 40. For example, the first test apparatus can be a I-V tester for testing current and voltage characteristics of circuitry of second photovoltaic module 40. Alternatively, the first test apparatus can be a HiPot tester, which applies a high voltage to circuitry of second photovoltaic module 40 to test the ability of the photovoltaic dielectric to withstand a high voltage. It should be apparent that a first test apparatus can be selected to test any known electrical characteristics of the circuitry of second photovoltaic module 40.

As previously noted, testing circuitry of second photovoltaic module 40 with the first test apparatus can generate test data, which can be saved in an electronic storage medium and compared to control data to determine the quality and fitness of the tested circuitry of second photovoltaic module 40 with respect to the test performed by the first test apparatus.

Finally, when connector 10 is rotated such that photovoltaic module 20 is located in unload station 4 as depicted in FIG. 4, a third photovoltaic module 60 can be transported into load station 1 by input bank 5. Third photovoltaic module 60 can be positioned and connected to connector 10 at first connection block 24 when, for example, connector 10 is rotated such that first connection block 24 is positioned in load station 1. Third photovoltaic module 60 can then be tested at first test station 2 and second test station 3 as described above. Testing multiple photovoltaic modules simultaneously increases the efficiency of the photovoltaic module production process.

While the invention has been described with reference to the above preferred embodiments, other embodiments are within the scope of the claims and it should be apparent that the described system and method can be altered and still fall within the scope of the claims. For example, it should be clear that the described system can be altered to accommodate additional testing stations or the testing of additional photovoltaic modules simultaneously. The embodiments described above are offered by way of illustration and example.

What is claimed is:

1. A system for testing a photovoltaic module comprising:
a connector having a rotation axis;
a load station peripheral to the connector configured to receive a photovoltaic module;
a first test station peripheral to the connector, wherein the connector forms an electrical connection with a first test apparatus when the connector is rotated to a first position; and
a second test station peripheral to the connector, wherein the connector forms an electrical connection with a second test apparatus when the connector is rotated to a second position.

2. The system of claim 1, further comprising an unload station peripheral to the connector configured to deliver the module to a position proximate to the unload station.

3. The system of claim 1, further comprising a photovoltaic module input bank configured to transport a photovoltaic module to the load station.

4. The system of claim 2, further comprising a photovoltaic module output bank configured to store a photovoltaic module from the unload station.

5. The system of claim 1, further comprising at least one additional test station, wherein the connector forms an electrical connection with a third test apparatus when the connector is rotated to a position corresponding to the additional test station.

6. The system of claim 1, wherein the first test station or the second test station comprises a current-voltage test apparatus.

7. The system of claim 1, wherein the first test station or the second test station comprises a high potential test apparatus.

8. The system of claim 1, further comprising at least one additional connector.

9. The system of claim 1, wherein the connector is a dial.

10. A dial, comprising:
a dial body;
a connector block attached at a predetermined location on the dial body; and
an axis around which the dial body and the predetermined location of the connector block may be rotated such that the connector block forms an electrical connection with an electrical test apparatus when the dial body is rotated around the axis to a position corresponding to the electrical test apparatus.

11. The dial of claim 9, further comprising a second position of the dial body around the axis corresponding to a second electrical test apparatus.

12. The dial of claim 9, further comprising at least one additional connector block.

13. The dial of claim 9, wherein the dial body includes a position proximate to the connector block for loading a photovoltaic module.

14. The dial of claim 12, further comprising a photovoltaic module loaded at the position proximate to the connector block and electrically connected with a lead wire to the connector block.

15. A method for testing a photovoltaic module, comprising:
connecting a photovoltaic module to a connector;
rotating the connector to a first test station to form an electrical connection between a first test apparatus, the connector, and the photovoltaic module;
testing the photovoltaic module at the first test station;
rotating the connector to a second test station to form an electrical connection between a second test apparatus, the connector block, and the photovoltaic module; and
testing the photovoltaic module at the second test station.

16. The method of claim 14, further comprising disconnecting the photovoltaic module from the connector.

17. The method of claim 14, further comprising testing the photovoltaic module with at least one additional test apparatus.

18. The method of claim 14, wherein the first test apparatus or second test apparatus comprises a current-voltage test apparatus.

19. The method of claim 14, wherein the first test apparatus or second test apparatus comprises a high potential test apparatus.

20. The method of claim 14, wherein the connector comprises a dial.

21. The method of claim 19, further comprising connecting a second photovoltaic module to the connector.

22. The method of claim 14, wherein the step of testing the photovoltaic module at the first or second test station comprises storing test data generated by the first test apparatus or the second test apparatus.

23. The method of claim 14, wherein the step of testing the photovoltaic module at the first or second test station comprises comparing the stored tests data to control data.
